(19) United States
(12) Patent Application Publication
(10) Pub. No.: US 2003/0014312 A1
(43) Pub. Date: Jan. 16, 2003

(54) Web based measurement of advertising success

(76) Inventor: Po-ling Fleisher, New South Wales (AU)

Correspondence Address: Albin H Gess, Price And Gess, Suite 250, 2100 S E Main Street, Irvine, CA, 92614, US

(21) Appl. No.: 10/204,525

(22) PCT Filed: Feb. 8, 2001
(86) PCT No.: PCT/AU01/00116

(30) Foreign Application Priority Data
Feb. 24, 2000 (AU) PQ 5820

(51) Int. Cl. G06F 17/60; G06F 15/173

(52) U.S. Cl. 705/14; 709/224

(57) ABSTRACT

A navigable computer site (web site) includes an information storage and retrieval means linked to the computer site. An associated magazine displays promotions of various products, services or the like. Each promotion has a unique promotion identifier associated with the promotion product/service. The navigable computer site is accessible by a registered reader who can input a unique promotion identifier relating to a particular promotion in the printed publication, to access further information on the product, service or the like associated with that promotion or the web site. Details of the readers accessing of that further information on the promotion are input to the database and are accessible to the organisation who placed the promotion via the navigable computer site following entry of an appropriate personal identifier relating to that organisation. This allows an advertiser placing a promotion to obtain real time feedback on the success or otherwise of a promotion in quantitative terms.

### FIELD OF THE INVENTION

This invention relates to a system incorporating a navigable computer site and a related print medium.

### BACKGROUND OF THE INVENTION

Printed publications such as magazines and newspapers carry advertisements as a source of revenue for the publisher in addition to the cover price (if any) of the publication. The proportion of the revenue for the printed publication that comes from advertising as opposed to the cover price, varies depending on the nature of the printed publication. Free magazines and free local newspapers clearly rely entirely on advertising to pay for their publishing and distribution costs. Trade magazines tend also to be in this category and are normally distributed free of charge to professionals and other persons involved in the relevant trade who are the target audience for the magazine's advertisers. For vendors of products and services, advertising in trade magazines clearly has advantages over advertising elsewhere as the advertisers can be assured that their advertisements are reaching their target audience. For example, a vendor of IT products or services will advertise in an IT trade magazine. However, advertising in trade magazines is expensive because the charges for advertisements have to cover all the publishing and distribution costs for the magazine. Further, present forms of trade magazine do not lend themselves to being able to measure the effectiveness of an advertiser's placement.

A second problem with trade magazines is that they fail to appreciate that most readers require quick and easy information and do not wish to wade through several pages of information and then get hit with an advertisement.

The invention seeks to address the disadvantages of the prior art described above.

### SUMMARY OF THE INVENTION

According to a first aspect of the present invention, there is provided a system comprising:

a navigable computer site;

an information storage and retrieval means linked to the computer site;

a printed publication including one or more promotions of various products, services or the like each promotion being associated with a unique promotion identifier; wherein

the navigable computer site is accessible by a reader who can input a unique promotion identifier relating to a particular promotion in the printed publication to access further information on the product, service of the like associated with that promotion and wherein details of the accessing of that further information on the promotion are input to the database and are accessible to authorised persons via the computer navigable site following entry of an appropriate personal identifier.

As used herein, the term navigable computer site, means ail Internet, Intranet, Extranet or like site which may be visited and explored.

Typically, the unique promotion identifier will be a number, referred to hereinafter as a web number.

It is highly preferred that each reader of the web site has their own unique personal identifier, typically a number, referred to hereinafter as a reader number. The reader number is associated with details of the reader including the name of the reader, their company and their business address.

The printed publication is typically a trade magazine and is sent to the registered readers with their personal identifier. In this way the details of the readers' accessing of the site, and the information they request can be tracked to build up a profile of the readers requirements.

Typically, the authorised persons will include the advertiser ie the client of personnel of the printed publication who arranged to have the promotion placed in the printed publication. Each authorised person will also preferably have their own unique identifier and associated password for accessing information stored concerning responses to their promotion.

The accessing of further information on a promotion by a reader may include information in the form of text files, pdf files, videos or the like, or may include a link to email the client who placed the promotion, or a hyperlink to the client's web site. The further information may also include price information such as the “recommended retail price” of the product and a list of resellers.

The information available to the authorised clients, typically include the number of times a particular promotion has been accessed on the computer navigable site and ie. whether the reader accessed further information, emailed the client, or hyperlinked to the client's web site.

Other information relating to the geographical spread of responses, a comparison of the advertiser's product or products against others in the same category, a comparison of responses to different categories of products and services, and fluctuations in product response over time.

The provision of such information to the client which can be simply accessed via the navigable computer site and is updated in real time provides feedback to the client so that client can assess the success of the promotion.

In a preferred feature, the client can obtain details of the particular readers accessing further information, sending emails, or hyperlinking to the client's web site, including the reader name, their company and their unique identifier. The client may also be able to obtain details of the numbers of readers who are interested in finding out about the cost of one of their products and ask for price information and the number and details of the product resellers that the reader sent emails to.

The invention also provides a navigable computer site for use with the system of the present invention and a printed publication for use with the system of the present invention.

In a related aspect, there is provided a method of providing further information or the like, relating to a published promotion in a printed publication comprising the steps of:

ascribing a unique promotion identifier to each promotion in the printed publication;

providing a navigable computer site accessible to readers of the printed publication, the site being linked to a database;

providing a means for a reader to input a unique promotion identifier relating to the promotion to the site in order to access further information or services related to the promotion;

providing further information or services related to the promotion at the web site on entry of the unique identifier;

recording details of the accessing of the further information or services associated with the promotion identified by the unique promotion identifier; making the details of the accessing of the further information or services associated with the promotion available to authorised persons on the web site.

Typically, the method includes the step of a reader inputting a unique number or other reader identifier identifying the reader prior to the reader being allowed to access information on promotions on the web site. The step of recording details of the accessing of the further information or services includes the step of recording the reader identifier in association with the promotion identifier.

### BRIEF DESCRIPTION OF DRAWINGS

The invention will be described, by way of example only, and with reference to the accompanying drawings in which:

FIG. 1 is a flow chart illustrating aspects of the functionality of a system embodying the present invention;

FIG. 2 shows a typical page from a trade magazine “Downloadit.com.au” embodying aspects of the present invention;

FIG. 3 is a screen dump showing a home web page of a web site, “Downloadit.com.au” embodying aspects of the present invention;

FIG. 4 is a screen dump showing the web page which appears after the reader number has been input;

FIG. 5 shows a screen dump of a web page relating to a product having a web number 0063;

FIG. 6 is screen dump of a home page from the web for clients (advertisers) in the magazine;

FIG. 7 is a screen dump of a web page illustrating sample responses to the client's products in real time;

FIG. 8 is a screen dump of a web page illustrating the client's exemplary bookings in the “Downloadit.com.au” magazine; and

FIG. 9 is a screen dump of a web page showing a Dynamic Variable Report on “Category”;

FIG. 10 is a screen dump of a web page showing a Dynamic Variable Report on “Performance”;

FIG. 11 is a screen dump of a web page showing a Dynamic Variable Report on “Location”; and

FIG. 12 is a screen dump of a web page showing a Dynamic Variable Report on “Quarter”.

### DETAILED DESCRIPTION OF A PREFERRED EMBODIMENT

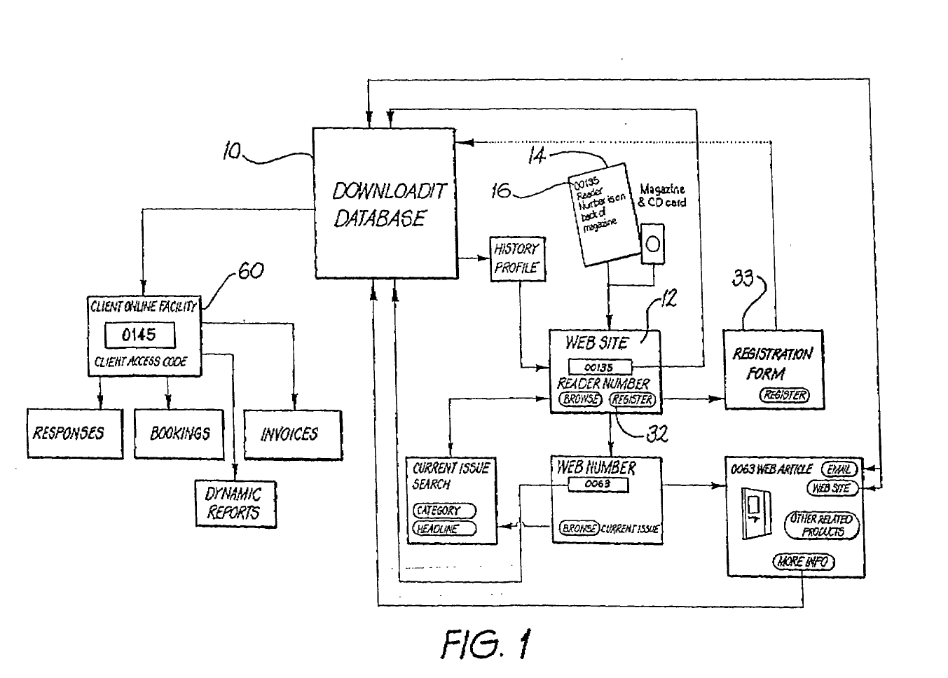

The main elements of the system are illustrated in FIG. 1 and include a database 10, a web site “Downloadit.com.au” 12, linked to the database for the transfer of data to and from the database, and a magazine 14 also called “Downloadit.com.au”.

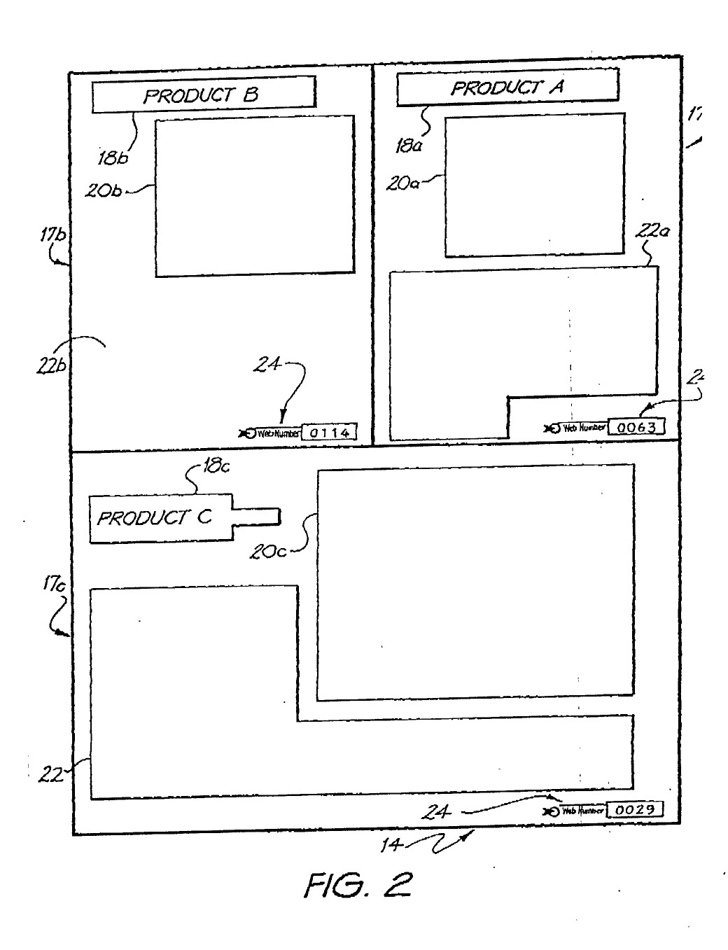

FIG. 2 shows a sample page from inside the magazine. The page shown in FIG. 2 displays three articles 17a, 17b, 17c. Each article includes a headline, 18a, 18b, 18c, respectively, and a graphic 20a, 20b, 20c, respectively, illustrating the product or service being advertised. Each article also includes a short description or copy (the teaser) 22a, 22b, 22c, respectively, relating to the product or service being advertised. Most importantly, each advertisement has its own individual identification code referred to as a “web number” 24. Thus in the case of the advertisement for “Product A” the web number is 0063. The web number for “Product B” is 0114. The web number for “Product C” is 0029. It is important that each advertisement/article has its own individual identification code distinct from the other advertisements, which as described, is the article's unique web number. A simple number is preferred as it is easier to use. However, it would, of course, be possible to have other systems of unique identifiers, such as number/letter combinations

The magazine “Downloadit.com.au” consists of a series of pages of short advertisements such as those illustrated in FIG. 2 illustrating products and services available to IT professionals and managers.

The back page of the magazine, gives the address for the “Downloadit.com.au” web site, and instructions for readers of the magazine on how to access and use the web site. The back page of the magazine also indicates the reader's unique personal identifier in the form of a reader number 16 (see FIG. 1). Each reader of the magazine and viewer of the web site has their own unique personal reader number. A mailing list, details of which are held in the Database 10, is associated with the magazine and includes each reader's reader number, their name, the company or organisation with which they are associated and their mailing address. The magazines are sent, typically quarterly, to those people on the mailing list and the personal address label for each reader includes their personal reader number.

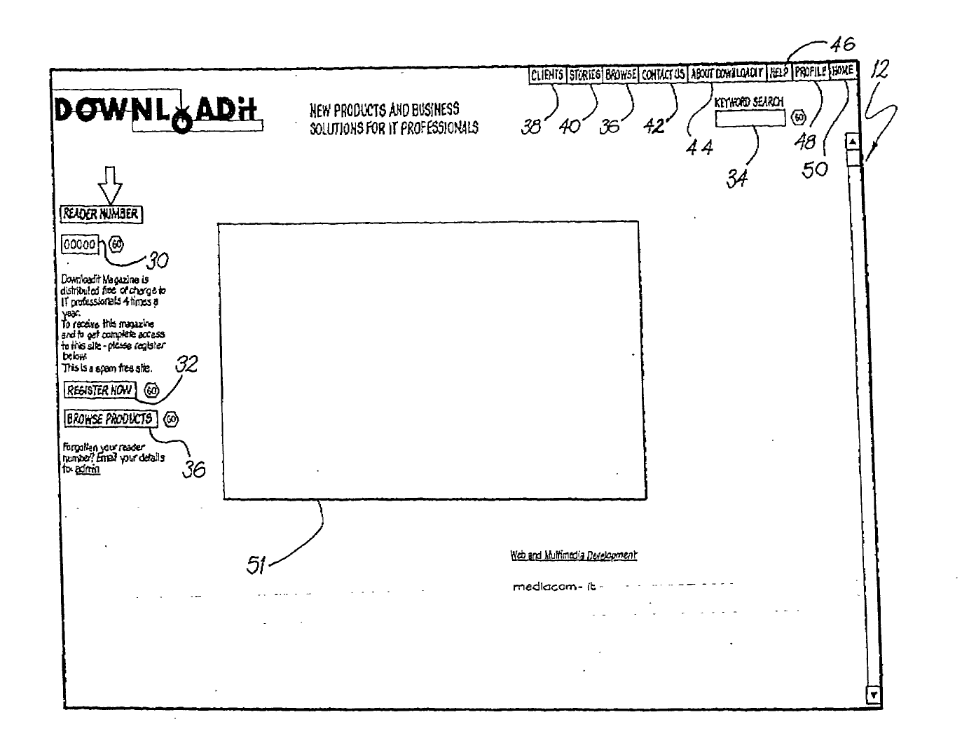

If the reader is interested in finding out more information about any of the products or services advertised, they do this via the “Downloadit.com.au” web site, screen dumps of which are shown in FIGS. 3 onwards.

Once the reader has accessed and down loaded the web site via their computer and browser, the home page of the web site appears first as shown in FIG. 3. FIG. 3 excludes extraneous information which would normally appear on the reader's computer screen such as the Navigation bar, browser logo, navigation icons and the like which are not relevant to the present invention. The home page provides a window 30 into which a reader can key in their reader number and a link 32 to a registration page to enable unregistered readers to register with “Downloadit.com.au”. The main page also provides a keyword search facility 34, a browse facility 36, a link to client's i.e. advertiser's pages 38, a link to news stories 40, a “contact us” link 42 to email the site, a link 44 to information about the site, a virtual help “button” 46, a link to reader profile pages 48 and a link 50 back to the home page.

The browse facility 36 can be activated by any reader of the web site regardless of whether or not they have previously registered or logged in. Unregistered viewers may see all the articles that are in the hard copy of the magazine. However, if they wish to see more information such as a pdf file, or if they wish to contact the advertiser by email or other means, they have to register. On requesting “more info” a pop screen appears inviting the reader to either log in or register. If they are registered the reader then simply inputs their reader number. Otherwise the reader registers with the site, as explained below. The home page also includes graphics and text 51 introducing and welcoming the reader to “Downloadit.com.au” and may include other text, icons, links, news items, as desired.

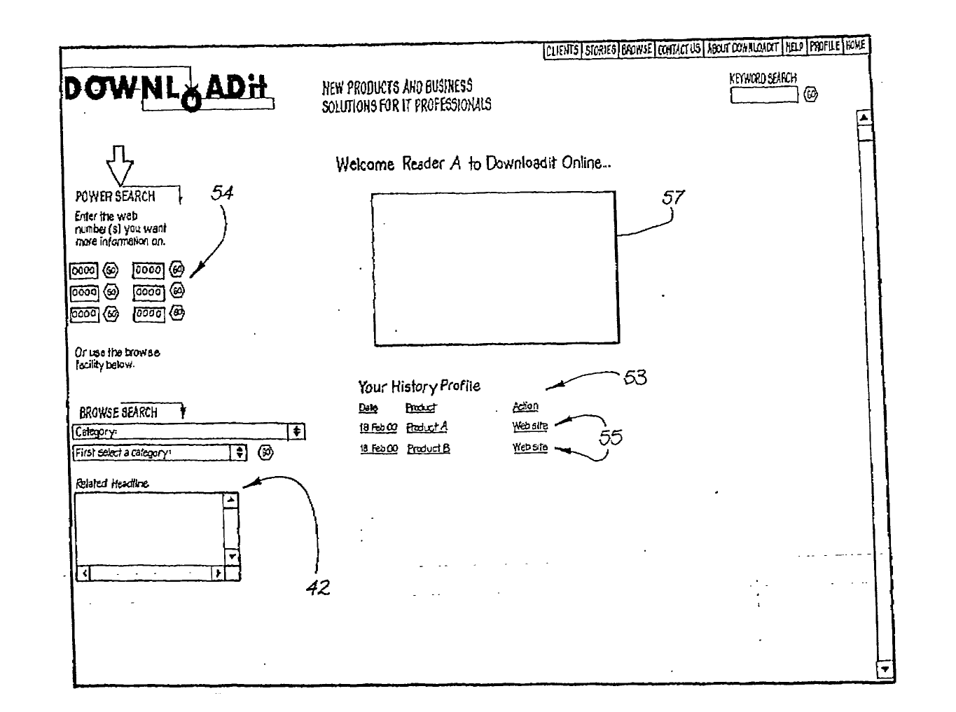

FIG. 4 shows an example of a typical reader index page for a reader, “Reader A” that is generated following input of their reader number and clicking on the “GO button” 52. At the left hand side of the page generally indicated by 54, is a “power search facility” which allows the reader to enter up to six web numbers 24 from the magazine relating to products or services to enable the reader to acquire further information on those products or services. A block of instructions and explanatory text 57 is provided in the centre of the web page. Below the text 57 the web page displays a profile of the reader which illustrates the dates on which the reader visited the site (Feb. 18, 2000), and tracks the articles they reviewed, so that they can go back and review the article again if desired. The action category 53 for both the “Product A” and “Product B” articles shows “Web site” 55 which indicates that the reader visited the web sites of the companies which placed the advertisements which were hyperlinked to those two products. Clicking on either “Product A” or “Product B”, will take the reader to the articles on those two products to be found on the “Downloadit.com.au” web site. Clicking on “Web site” 55 again, will hyperlink the reader directly to the web sites of the respective organisations who placed the advertisements for those products.

With reference to FIG. 1, all this information is downloaded into the reader's browser from the “Downloadit.com.au” database 10 after the reader number is input. Any actions taken by the reader after their reader number is input are also input into the database and stored.

Returning to FIG. 3, if the person viewing the web site is not registered with the site or magazine, clicking on the “register now” link 32, will produce a registration form 33 (see FIG. 1). The unregistered reader then keys in their details and that data is input into the database 10 whereupon, the database will allocate a reader number to that reader.

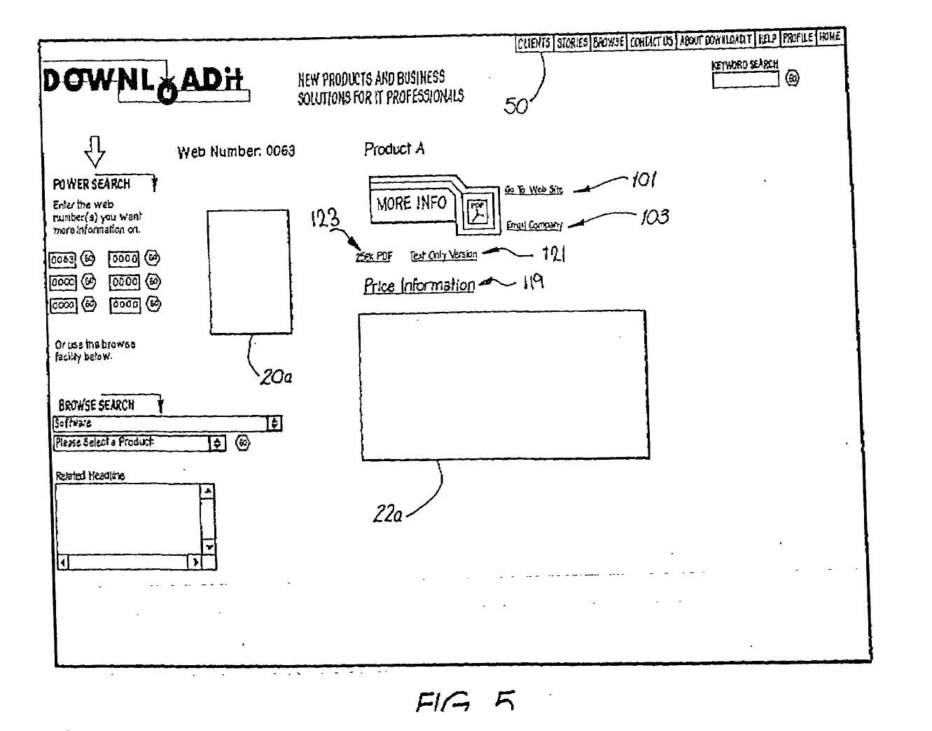

Returning to FIG. 4, the reader will typically be seeking to obtain further information on one or more of the products advertised in the magazine and will therefore key in the web number of the product or products of interest, in the “Power Search” 54. In the present example, the web number 0063 is input, in which case the next web page which appears on the reader's browser, is that shown in FIG. 5. The web number 0063 is sent to the database. The database sends the relevant information to the reader's browser. The web page replicates the magazine advertisement whose web number is 0063. Because the display largely mirrors that of the magazine page, the reader is instantly familiar and comfortable with the display and this confirms that the correct web number has been entered. The page provides a number of options for the reader. Option 101 which is “Go to Web Site” is a hyperlink directly to the web site of the advertiser who placed the article on Product A in the magazine. Option 103 “Email Company” allows the reader to send an email directly to that advertiser. Links are also provided to the allow the reader to get more information on the product either in a “Text Only Version” 121 form or as a “256k PDF” 123. Of course other options are possible for supplying additional information such as QTVR, video or any other files or information in electronic format relating to the product may be made available via appropriate links. Option 119 is “Price Information”.

Clicking on the “Price Information” link 119 provides the “recommended retail price” of the product and a list of resellers. The list of resellers includes each reseller's name, email, phone and fax details. This provides the necessary information to allow a reader to make contact with a reseller for detailed information, or to purchase the product. Thus readers will be able to view a product in the magazine and then instantly purchase it online.

Information is sent back to the database 10 recording the accessing of a product by the reader. The database knows the identity of the reader, from the reader number, the product from the web number and information relating to the response to the advertisement ie. which link(s) is/are accessed is also sent to the database in real time. Advertisers, can then access the database 10, obtain information in real time relating to responses to their advertisements in the magazine. This is also done through the web site via a “client” (i.e. advertiser in this specification, “client” and “advertiser” are essentially synonyms) home page which is accessed, see FIG. 3, by clicking on the “Clients” link 38 on the home page. The client home page, not illustrated, provides a box for the client to enter their access code in order to access information relating, to reader's responses to their articles.

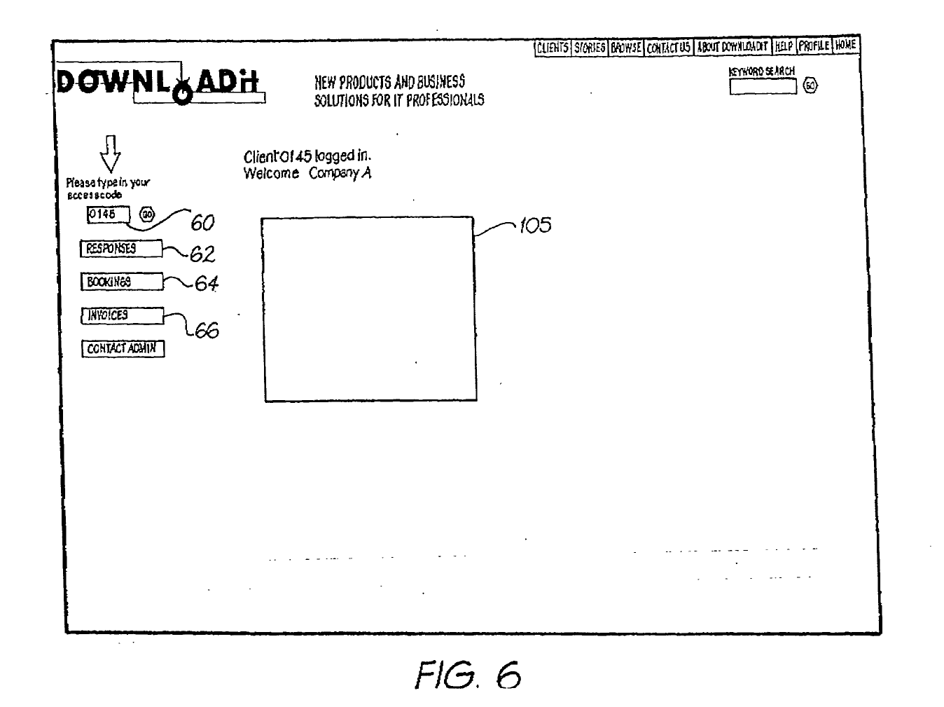

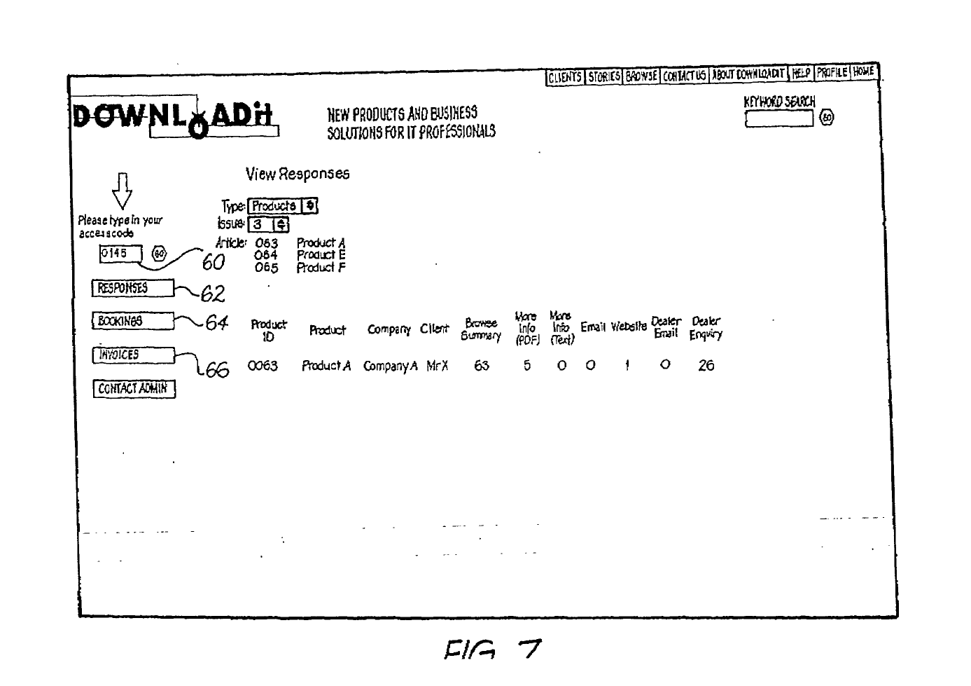

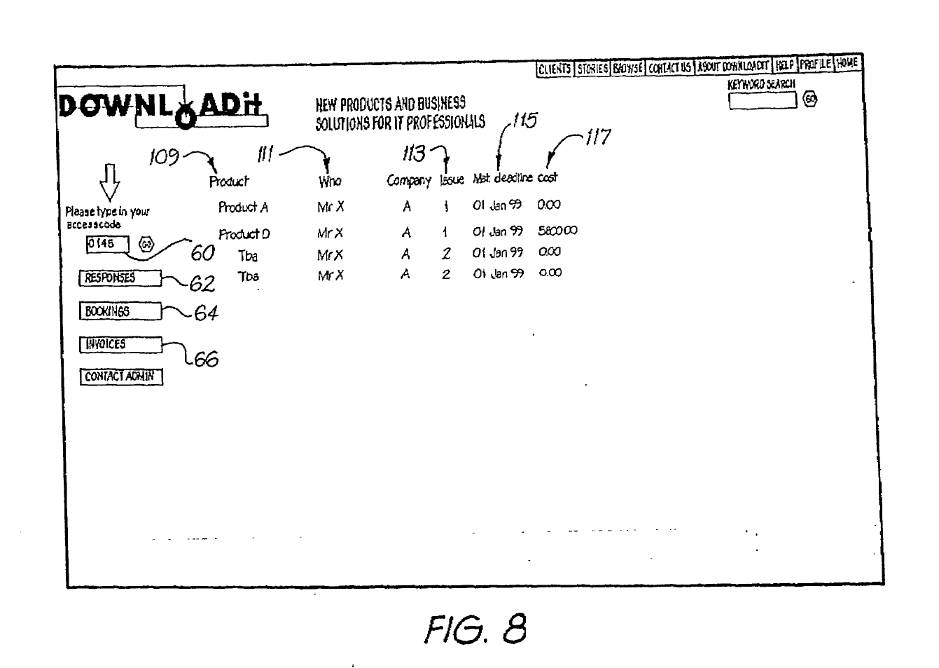

Once the client's access code (in this example 0145) and password has been input, a screen display see FIG. 6 appears and the client can look at the responses to their advertisements via link 62, (see FIG. 7) their bookings (see FIG. 8) via link 64, and a history of their invoices with “Downloadit.com.au”—via link 66. All this information is downloaded from the database 10 (see FIG. 1). Box 105 is a paragraph welcoming clients to their site.

For example, FIG. 7 is a web page showing the response to one of three advertisements/articles placed by “Company A” in issue 3 of the magazine being an advertisement/article on Product A having a web number 0063. As shown, there were sixty-three hits on Product A. Those hits resulted in 5 requests for more information in the form of a PDF file, one hyperlink to Company A's web site, and twenty-six “Dealer Enquires” which equates to the number of readers interested in finding out the cost of a product and clicking on the price information option 119. There were no requests for more information in text form and no emails to the advertiser or to the dealer. The client may also view responses in more detail by clicking on the number of hits they had on each option which downloads from the database, the details (reader number, name and company) of the people responding. Thus the response to an advertisement can be properly assessed in terms of the number of readers requesting further information and the identity of the interested readers.

The client home page also provides online dynamic reports. The online dynamic reports are split into four reports namely “Category”, “Performance”, “Location” and “Quarter”.

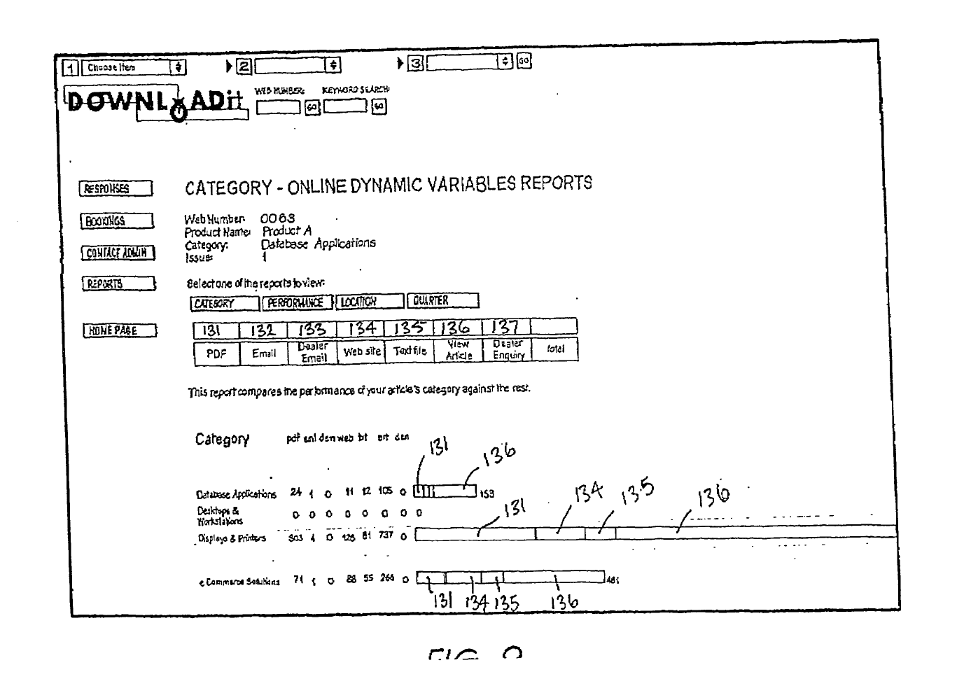

The Category report compares the category performance of a product against the other categories. For example with reference to FIG. 9 Product A is in the category “Database Applications”. The category report compares the overall response of that category with that of other categories such as “Desktops and Workstations”, “e-Commerce Solutions”, Displays and Printers” etc. Many categories have been omitted from FIG. 9 to avoid over-complicating the Figure which is illustrative only. The display shows the trend of the category—typically a category such as “Displays and Printers” will receive a higher response due to its interest to a wider audience than say “Database applications”.

The report is presented as a coloured bar chart, each response type PDF, Email, Dealer Email, Website, Text File, View Article, Dealer Inquiry is associated with a particular colour 131 to 137 respectively. The bar chart is made up of bands of those colours reflecting the number of responses in those categories.

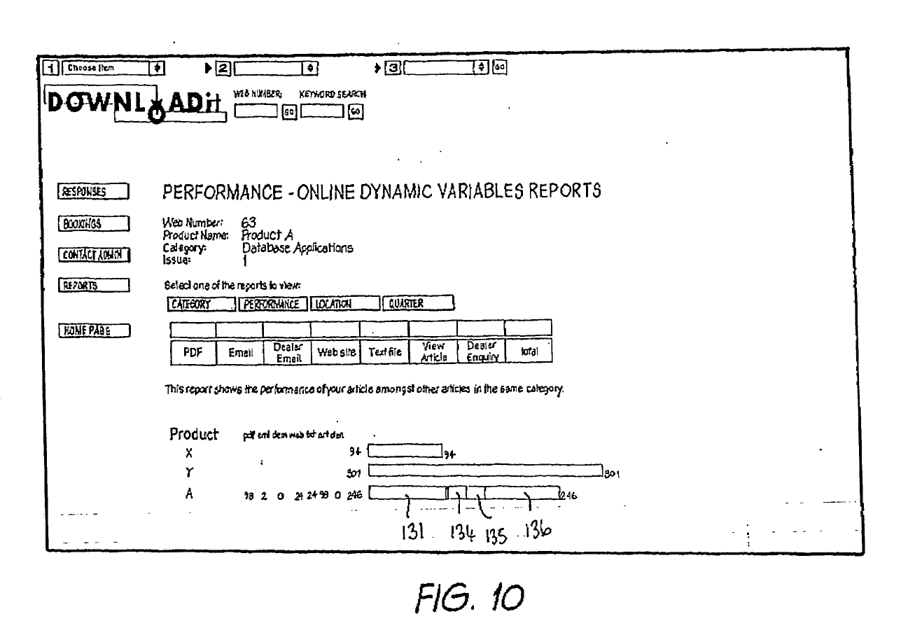

The second type of report is “Performance”. This report shows the performance of one product compared with its competitors in the same category. FIG. 10 illustrates Product A compared with products X and Y. This report demonstrates how well a product is received in comparison to its competitors. The report is again a bar chart made up of coloured bands reflecting the number of responses in each category. (This feature is illustrated for product A only in the Figure). The weeks are broken down day by day and the report presented as a coloured bar chart, as above. Again the report is presented as a coloured bar chart visually reflecting the number of responses of each type.

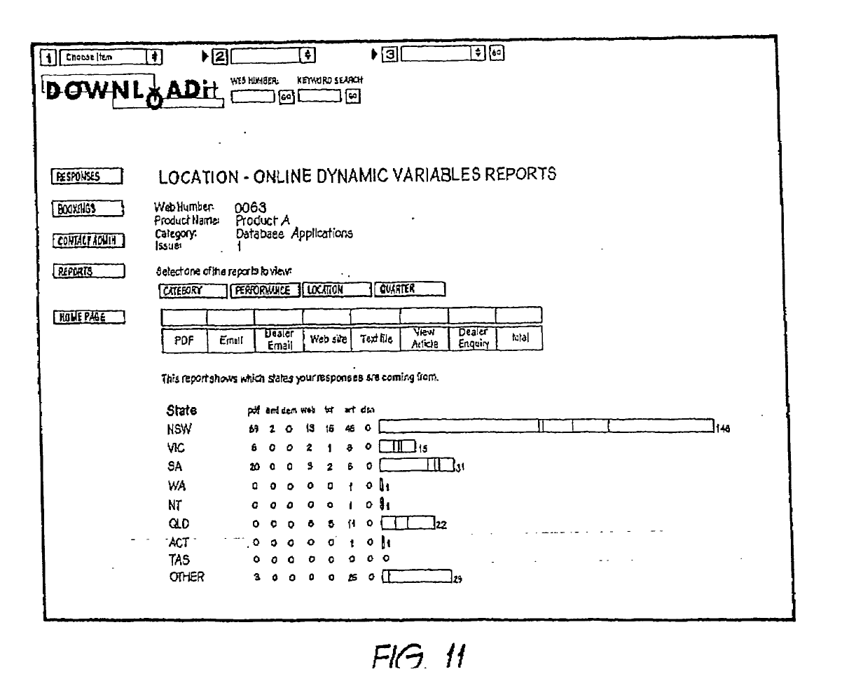

The third report is “Location”. This category shows the areas, in this case States, where responses to advertisements originate. As seen in FIG. 11 the majority of the responses to “Product A” originate in New South Wales.

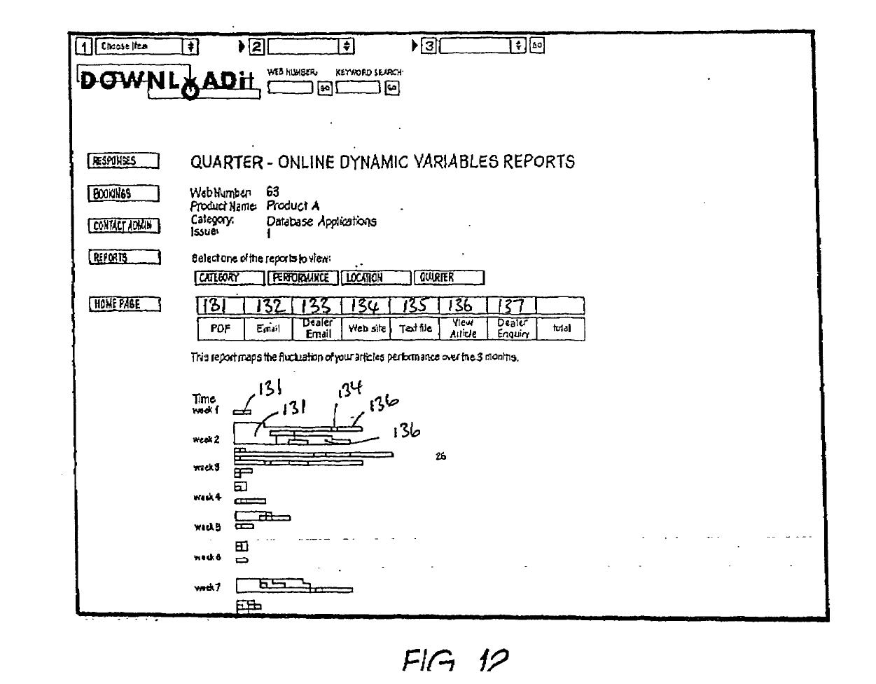

The final category is “Quarter” This report maps the fluctuations of a products performance over a three month period. FIG. 12 shows the responses to “Product A” over the first seven weeks of a quarter.

The advertiser can also view past and future bookings in the “Downloadit.com.au” magazine. FIG. 8 provides a typical web page showing “Company A's” bookings in Issue 1 and Issue 2 of the magazine. The information includes the name 109 of the product advertised (where this information is available), the contact 111 (“Mr X”) at the company who made the booking, the issue number 113 of the magazine, and the deadline 115 for the submission of the copy and other material for the advertisement and the cost 117. This makes it considerably easier for the advertiser to check their deadlines without having to search through paperwork or contact the publishers of the magazine “Downloadit.com.au”.

A further web page not illustrated is available to the advertiser which allows the advertiser access to the history of their invoices with “Downloadit.com.au” checking which invoices they have paid, and which invoices may be overdue.

Typically, the magazine will be published quarterly, so that at the end of each quarter, or when an article is due to expire, ie not be renewed in the subsequent issue of the magazine, client advertisers may use an online booking facility to maintain their product on the web site, although the article will not be repeated in the magazine. Clicking on an appropriate virtual button, produces an email form which the advertiser can use to request maintenance of the article on the web site by marking the appropriate 3 month, 6 month or 9 months box and clicking a “submit” virtual button to submit it to the database.

As discussed above, to maintain the relevance of the current issue of the magazine, the browse facility is restricted to the current issue, although once a particular article has been viewed, facility to view other related products in the same category by clicking on the appropriate link 106, (see FIG. 1) presents articles that are current and past products in that category.

Although the present invention has been described in terms of a magazine and related web site relating to the IT industry, clearly the system of the present invention can be applied to other areas of commerce such as manufacturing, pharmaceuticals, marketing as well as IT, as professionals in those areas of commerce become more and more comfortable with using the Internet to obtain information.

It should be noted that the most difficult aspect in measurable media is to show the advertiser first the number of parties interested in their product, secondly who they are, and how many of those interested parties converted to an actual sale of the advertised product. The present invention provides much of this information to an advertiser.

Security and password protection may be incorporated into the system to prevent unauthorised use of client or reader numbers. The implementation of such protection would be a matter of routine for the person skilled in the art.

It will be appreciated by persons skilled in the art that numerous variations and/or modifications may be made to the invention as shown in the specific embodiments without departing from the spirit or scope of the invention as broadly described. For example, the design appearance and functionality of the web site may change and develop. The present embodiments are, therefore, to be considered in all respects as illustrative and not restrictive.

1. A system comprising:
a navigable computer site;
an information storage and retrieval means linked to the computer site;
a printed publication including one or more promotions or advertisements, each promotion or advertisement being associated with a unique promotion identifier; wherein
the navigable computer site is accessible by a reader who can input a unique promotion identifier relating to a particular promotion or advertisement in the printed publication to access information on an offer associated with that promotion or advertisement and wherein details of the accessing of that information on the promotion or advertisement are input to the database and are accessible to authorised persons.

2. A system as claimed in claim 1 wherein the navigable computer site is an Internet, Intranet, Extranet or other computer site, which may be visited and explored by the reader.

3. A system as claimed in claim 1 wherein access to certain further information is restricted to readers who have registered and obtained their own unique personal identifier.

4. A system as claimed in claim 1 wherein the printed publication is magazine sent to readers who are registered with the navigable computer site together with the reader's unique personal identifier.

5. A system as claimed in claim 1 wherein the category of authorised persons includes advertisers who have had promotions or advertisements placed in the printed publication, and wherein access to information on the database is permitted via the computer navigable site to authorised persons following entry of an appropriate personal identifier.

6. A system as claimed in claim 3 wherein the accessing of further information on a promotion or advertisement by a reader includes the provision of information in the form of text files, pdf files, or videos.

7. A system as claimed in claim 3 wherein the site is arranged to provide further information on a promotion or advertisement to a reader said provision of further information including the provision of a link to email the client who placed the promotion or advertisement, or a hyperlink to the client's web site.

8. A system as claimed in claim 3 wherein the site is arranged to provide further information to a reader including price information and details of resellers of a product or service where a product or service is the subject of the promotion.

9. A system as claimed in claim 5 wherein the information made available to the authorised persons includes data relating to the number of times a particular promotion or advertisement has been accessed on the computer navigable site.

10. A system as claimed in claim 9 wherein the information made available to the authorised clients further includes data relating to whether the reader accessed further information, emailed the client, or hyperlinked to the client's web site.

11. A system as claimed in claim 10 wherein the information is updated in real time.

12. A system as claimed in claim 8 wherein the promotion or advertisement is a promotion of a product or service and wherein information made available to authorised persons includes one or more of:
geographical spread of interest in the product or service;
reader response to a product compared to other products in the same category;
variation in response to different categories of product or service;
variations in response to a promotion over time.

13. A system as claimed in claim 10 wherein the authorised person may obtain details of any readers accessing further information, sending emails, or hyperlinking to the client's web site, including the reader's name, their organisation if they are associated with an organisation and their unique identifier.

14. A method of providing further information or the like, relating to a published promotion or advertisement in a printed publication comprising the steps of:
ascribing a unique promotion identifier to each promotion or advertisement in the printed publication;
providing a navigable computer site accessible to readers of the printed publication, the site being linked to a database;
providing a means for a reader to input a unique promotion identifier relating to the promotion or advertisement to the site in order to access further information or services related to the promotion or advertisement;
providing further information or services related to the promotion or advertisement at the web site on entry of the unique identifier;
recording details of the accessing of the further information or services associated with the promotion or advertisement identified by the unique promotion identifier; and
making the details of the accessing of the further information or services associated with the promotion available to authorised persons.

15. A method as claimed in claim 14 further including the step of a reader inputting a unique identifier identifying the reader prior to the reader being allowed to access information on promotions or advertisements on the web site.

16. A method as claimed in claim 15 wherein the step of recording details of the accessing of the further information or services includes the step of recording the use of the unique identifier to access information on promotions.

17. A navigable computer site associated with an information storage and retrieval means linked to the computer site, wherein the navigable computer site is accessible by a registered reader, each registered reader having a unique personal identifier, the site allowing a reader to input a unique promotion identifier relating to a particular promotion or advertisement to access further information on a product, service associated with that promotion or advertisement wherein details of the registered reader accessing of that further information on the promotion are input and are accessible to authorised persons via the computer navigable site.

18. A navigable computer site as claimed in claim 17 wherein the navigable computer site is an Internet, Intranet, Extranet or other computer site, which may be visited and explored by the reader.

19. A navigable computer site as claimed claim 17 wherein the category of anthorised persons includes advertisers who have had promotions or advertisements placed in the printed publication.

20. A navigable computer site as claimed in claim 17 wherein the accessing of further information on a promotion by a reader includes the provision of information in the form of text files, pdf files, or videos.

21. A navigable computer site as claimed in claim 17 wherein the accessing of further information on a promotion by a reader includes the provision of a link to email the client who placed the promotion or advertisement, or a hyperlink to the client's web site.

22. A navigable computer site as claimed in claim 21 wherein the information made available to the authorised persons includes data relating to the number of times a particular promotion or advertisement has been accessed on the computer navigable site.

23. A navigable computer site as claimed in claim 23 wherein the information available to the authorized clients further includes data relating to whether the reader accessed further information, emailed the client, or hyperlinked to the client's web site.

24. A navigable computer site as claimed in claim 23 wherein the information is updated in real time.

25. A navigable computer site as claimed in claim 23 arranged to display to an authorised person, details of a reader accessing further information, sending emails, or hyperlinking to the client's web site, including the reader's name, their organisation if they are associated with an organisation.

26. A navigable computer site as claimed in claim 17 wherein the further information provided by the web site includes price information and a list of resellers of a product or service which is the subject of a promotion.
